(19) United States
(12) Patent Application Publication
(10) Pub. No.: US 2018/0018666 A1
(43) Pub. Date: Jan. 18, 2018

(54) METHODS AND SYSTEMS FOR SECURING A PAYMENT

(71) Applicant: Mastercard International Incorporated, Purchase, NY (US)

(72) Inventors: Vivek Hareshbhai SOLANKI, Surat (IN); Ankit PATEL, Idar (IN); Tanvi PATEL, Gujarat (IN); Pratik PATEL, Akota (IN); Vaibhav VORA, Subhanpura (IN)

(73) Assignee: Mastercard International Incorporated, Purchase, NY (US)

(21) Appl. No.: 15/629,897

(22) Filed: Jun. 22, 2017

(30) Foreign Application Priority Data
Jul. 14, 2016 (SG) 10201605789V

(51) Int. Cl. G06Q 20/40; G06Q 20/32; G06Q 10/10; G06Q 20/36

(52) U.S. Cl. CPC G06Q 20/405; G06Q 20/36; G06Q 20/3278; G06Q 10/107; G06Q 20/3255; G06Q 20/3274

(57) ABSTRACT

A method and system are presented for securing a payment initiated by a payee. The method comprises the operations of: a service provider (i) receiving a request from a payee for a payment transaction to be made, the request comprising a payee identifier, payer identifier and transaction amount; (ii) generating a token associated with the request; and (iii) transmitting the token to the payer. The service provider (i) receiving the token and a payer identifier from the payer, (ii) using the token to retrieve details of the request, and (iii) transmitting the payee identifier and transaction amount to the payer for authorization. Upon authorization, the service provider receiving from the payer, identification of a payer payment vehicle to be used for the payment transaction such that the service provider may complete the payment transaction from the payer payment vehicle to a payee payment vehicle.

### FIELD OF THE INVENTION

The present invention relates to methods and systems for securing a payment initiated by a payee. The payee may be a merchant or an individual. Notably, the payment may be initiated without the payer being in the same location as the payee.

### BACKGROUND OF THE INVENTION

To date, the use of digital wallets has primarily related to on-line shopping with on-line merchants.

Peer-to-peer payment (P2P payment, also called person-to-person payment) is an online technology that allows a “payer” to transfer funds from a payment account associated with the payer, to a payment account associated with a “payee” via the Internet or a mobile phone. The payer may for example be a customer of a payee who is a merchant. Typically, neither the payer nor the payee has to trust the other with information about his or her payment account.

There are two conventional methods for initiating a P2P payment. In the first method, the payer and payee establish secure accounts with a trusted third-party vendor (typically, a financial institution), designating their respective bank account or credit card information to be used to transfer and accept funds. Using the third party's website or a mobile application, the payer and payee can complete the process of sending or receiving funds. However, the payer needs to initiate the payment and can only send funds to a payee who is also registered with the third party vendor.

In the second method, the payer uses an online interface or mobile application (typically provided by his or her bank or another financial institution) to contact a third party site. To initiate the transfer, the payer indicates the amount of funds to be transferred, and provides contact data for the payee (an email address or phone number). Once the transfer has been initiated by the payer, the payee receives a notification using the contact data. The payee uses the online interface or mobile application to input his or her payment account information (e.g. the number of a payment account held by a bank, and details of the bank) to accept the transfer of funds. In this second method, payees do not need to have a payment account with the same financial institution as the payer in order to receive a money transfer.

While the above systems are adequate for online payments, physical stores typically still require a point-of-sale terminal (POS), near field communication (NFC), Acquirer charges and full time internet to facilitate cashless payment transactions. Such requirements are relatively expensive for small-sized and newly established merchants.

One proposal that may address some of the above concerns requires a merchant to identify itself to the customer by encoding the merchant's account details in the form of a Quick Response (QR) code to be scanned by a customer's mobile device so that the customer can then transfer the required funds to the merchant. Although this system is secure from the customer's perspective as it does not require the customer to share account details with the merchant, it does require that the merchant account details be passed directly to the customer. Furthermore, in this case, the QR code is a static code that remains the same for all transactions and it is the customer that is required to initiate the transaction by entering details such as the transaction amount into his/her mobile device.

There is therefore a need for methods and systems for securing a payment initiated by a payee.

### SUMMARY OF THE INVENTION

In accordance with a first aspect of the present invention there is provided a method of securing a payment initiated by a payee comprising the operations of:
a) a service provider (i) receiving a request from a payee for a payment transaction to be made, the request comprising a payee identifier and transaction amount; (ii) generating a token associated with the request; and (iii) transmitting the token to the payer;
b) the service provider (i) receiving the token and a payer identifier from the payer; (ii) using the token to retrieve details of the request; and (iii) transmitting the payee identifier and transaction amount to the payer for authorization;
c) upon authorization, the service provider receiving from the payer, identification of a payer payment vehicle to be used for the payment transaction; and
d) the service provider completing the payment transaction from the payer payment vehicle to a payee payment vehicle.

Embodiments of the invention therefore provide a method of securely transferring funds from a payer to a payee when a cashless transaction is initiated by the payee. In this case, only the service provider obtains the payment vehicle information (e.g. account information) for the payer and payee. Thus, the payment vehicle information remains more secure than for traditional transactions. Furthermore, a payee initiated transaction will be faster and more convenient for a payer to complete than if the payer were to initiate the transaction him/herself since the payer does not need to provide any details to the payee or service provider (e.g. to identify the payee or transaction amount) to initiate the transaction.

Advantageously, embodiments of the invention can be applied to face-to-face or distance transactions where the payer and payee are not in the same location. Thus, the transaction may be requested (and completed) at any time and from any location.

The payee may be a merchant or an individual (e.g. friend, family, colleague of the payer). In fact, embodiments of the invention may be utilised by any persons or entities wishing to transfer funds. A particular aim of specific embodiments is to provide a convenient solution for cashless transactions and to reduce (or eliminate) the need for physical payment cards (e.g. plastic cards).

Embodiments of the invention provide a simple and secure solution through which a user can become a payer or a payee for a person to person fund transfer. The solution can be employed for day-to-day transactions without hardware dependencies like a point-of-sale (POS) terminal, Automated Teller Machine (ATM), checking payment system, Near-Field Communication (NFC) payment system and plastic cards.

Embodiments of the invention may leverage a user's mobile device as a channel of communication for initiating and/or authorising payments.

In some embodiments, use of the method proposed may be monitored and rewards provided to users making frequent use.

Advantageously, the token is unique to each request. In some embodiments, the token may be generated using the payee identifier and/or the transaction amount. The token may comprise a code which may comprise numerals, letters, symbols and/or images.

The step of transmitting the token to the payer may comprise displaying or otherwise transmitting a Quick Response (QR) code or transmitting the token via an email, Short Message Service (SMS), Near-Field Communication (NFC), Bluetooth or other communication means to a payer's mobile device (e.g. smartphone, laptop, tablet etc.). In some embodiments, the token may be transmitted to the payer via the payee (e.g. the service provider may transmit the token to the payee and the payee may further transmit the token to the payer, for example, by displaying the token in the form of a QR Code).

The payee identifier and/or the payer identifier may comprise one or more of a name, residential address, mobile number, email address, company/individual identity code, registration code or user ID (i.e. where the payee/payer has pre-registered with the service provider). Notably, the payee identifier transmitted by the payee to the service provider and the payee identifier transmitted by the service provider to the payer need not be the same. For example, where the payee is registered with the service provider, the payee may identify itself to the service provider using a registration code. However, this may not enable the payer to identify the payee and so the payee identifier transmitted to the payer may be the payee name (which may be stored in the registered user database described below).

The payer payment vehicle and/or the payee payment vehicle may comprise any suitable cashless payment mechanism, such as a credit card, a debit card, a prepaid card, a charge card, a membership card, a promotional card, a frequent flyer card, an identification card, a gift card, and/or any other physical or electronic device that may hold payment account information, such as digital wallets. Thus, the payer payment vehicle and/or the payee payment vehicle may each take the form of a payment card or a digital wallet. Notably, the payer payment vehicle need not be the same type of cashless payment mechanism as the payee payment vehicle.

In operation d), the service provider may complete the payment transaction through a payment network (e.g. by transmitting an authorization request to an acquirer bank associated with the payee payment vehicle which processes the authorization request and transmits a payment request to an issuer bank associated with the payer payment vehicle). Once approved by the issuer bank, the payment is transferred to the acquirer bank for storing in the payee payment vehicle. In some embodiments, the service provider may comprise a digital wallet service provider configured to complete the payment transaction through a digital wallet payment.

The method may further comprise a registration procedure wherein the payee and/or payer pre-register with the service provider to make and/or receive payments through the service provider.

The service provider may create and/or maintain a user database comprising details of registered payers and/or payees. The details may comprise one or more of: a payee/payer identifier, name, residential address, mobile number, email address, company/individual identity code, registration code, user ID and registered payment vehicle (e.g. preferred payment card, payment account or digital wallet). Thus, the identification of a payer payment vehicle may comprise confirmation that a registered payment vehicle associated with the payer in the database is to be used. Alternatively, the identification of a payer payment vehicle may comprise identification of a cashless payment mechanism such as a payment card, payment account or digital wallet.

The service provider may create and/or maintain a transaction database comprising details of the requested payment transactions. Thus, the transaction database may comprise the payee identifier, transaction amount and token associated with the request. Accordingly, in operation b), the service provider may use the token to retrieve the payee identifier and transaction amount from the transaction database.

Upon authorization, the service provider may check that it has not previously received an authorization pertaining to the same token, with operation d) only being performed in the case that the check has a positive result.

In accordance with a second aspect of the present invention there is provided a service provider server for securing a payment initiated by a payee comprising a processor arranged to:
a) receive a request from a payee for a payment transaction to be made, the request comprising a payee identifier and transaction amount;
b) generate a token associated with the request;
c) transmit the token to the payer;
d) receive the token and a payer identifier from the payer;
e) use the token to retrieve details of the request;
f) transmit the payee identifier and transaction amount to the payer for authorization;
g) upon authorization, receive from the payer, identification of a payer payment vehicle to be used for the payment transaction; and
h) complete the payment transaction from the payer payment vehicle to a payee payment vehicle.

The processer may be arranged to encrypt the token before transmitting it to the payee and to decrypt the token, upon receiving it from the payer.

In embodiments of the invention, the service provider may be configured to also handle payment transactions initiated by the payer.

A payer and/or payee application may be provided to run on a payer/payee mobile device to facilitate embodiments of the invention.

Embodiments of the invention may be expressed as a network of communicating devices (i.e. a “computerized network”). It may further be expressed in terms of a software application downloadable into a computer device to facilitate the method. The software application may be a computer program product, which may be stored on a non-transitory computer-readable medium on a tangible data-storage device (such as a storage device of a server, or one within a communication device).

### BRIEF DESCRIPTION OF THE DRAWINGS

Embodiments of the invention will now be described by way of example only with reference to the following drawings, in which:

FIG. 1 illustrates a method for securing a payment initiated by a payee in accordance with a first embodiment of the invention;

FIG. 2 illustrates a computerised network of electronic devices for performing the method of FIG. 1;

FIG. 3 shows a flow chart for a computerised method for securing a payment initiated by a payee in accordance with a second embodiment of the invention, wherein a customer wishes to pay a merchant in person (or online);

FIG. 4 shows a flow chart for a computerised method for securing a payment initiated by a payee in accordance with a third embodiment of the invention, wherein a customer wishes to pay a merchant for products purchased by telephone;

FIG. 5 shows a flow chart for a computerised method for securing a payment initiated by a payee in accordance with a fourth embodiment of the invention, wherein a request for a payment transaction is communicated via email;

FIG. 6 shows a flow chart for a computerised method for securing a payment initiated by a payee in accordance with a fifth embodiment of the invention, wherein a request for a payment transaction is communicated via a mobile telephone network;

FIG. 7 shows a flow chart of a payer/payee registration procedure in accordance with some embodiments of the invention;

FIG. 8 shows a flow chart illustrating a user application interface for use by a payer or payee in accordance with some embodiments of the invention;

FIG. 9 shows a block diagram of the technical architecture of the server of FIG. 2; and

FIG. 10 shows a block diagram of the communication devices of FIG. 2.

### DETAILED DESCRIPTION OF CERTAIN EMBODIMENTS

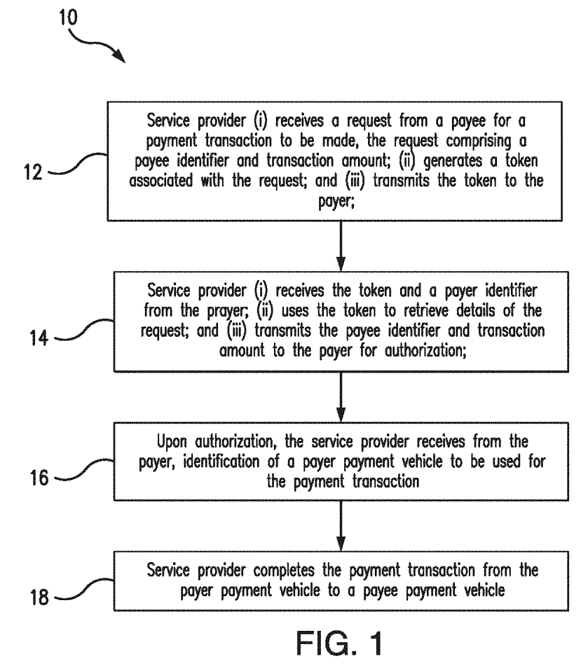

FIG. 1 shows a method 10 for securing a payment initiated by a payee in accordance with a first embodiment of the invention. The method 10 comprises the following steps:
Step 12: a service provider (i) receiving a request from a payee for a payment transaction to be made, the request comprising a payee identifier and transaction amount; (ii) generating a token associated with the request; and (iii) transmitting the token to the payer;
Step 14: the service provider (i) receiving the token and a payer identifier from the payer; (ii) using the token to retrieve details of the request; and (iii) transmitting the payee identifier and transaction amount to the payer for authorization;
Step 16: upon authorization, the service provider receiving from the payer, identification of a payer payment vehicle to be used for the payment transaction; and
Step 18: the service provider completing the payment transaction from the payer payment vehicle to a payee payment vehicle.

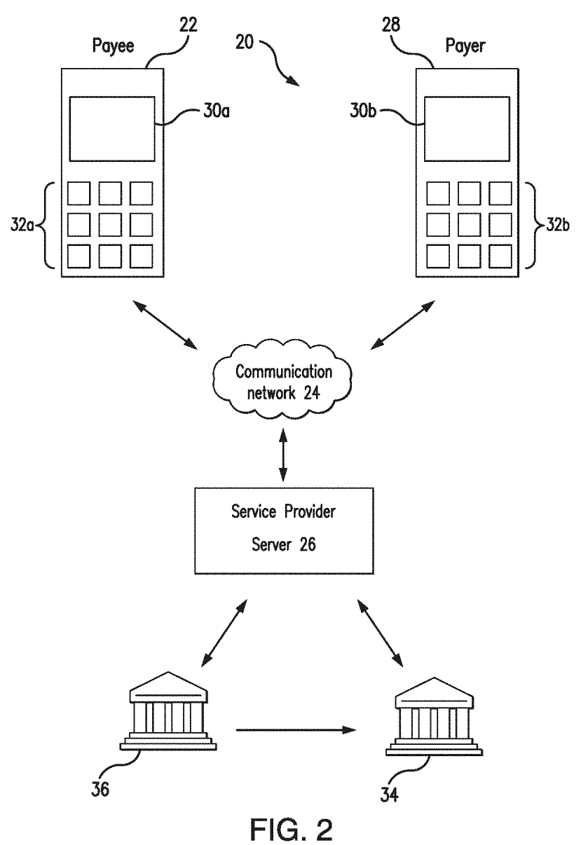

FIG. 2 illustrates a computerized network 20 of electronic devices for performing the method of FIG. 1. Thus, the network 20 comprises a payee mobile device 22, connected via a communication network 24 to a service provider server 26. A payer mobile device 28 is also shown in communication with service provider server 26 through the communication network 24. The payee mobile device 22 is associated with a person who wishes to request a fund transfer from the payer. In FIG. 2, the payee mobile device 22 and the payer mobile device 28 are depicted as smartphones, however they may each be constituted by any electronic communication device, such as a tablet computer, laptop, personal computer, or, in the case where the payee is a merchant, a point-of-sale terminal.

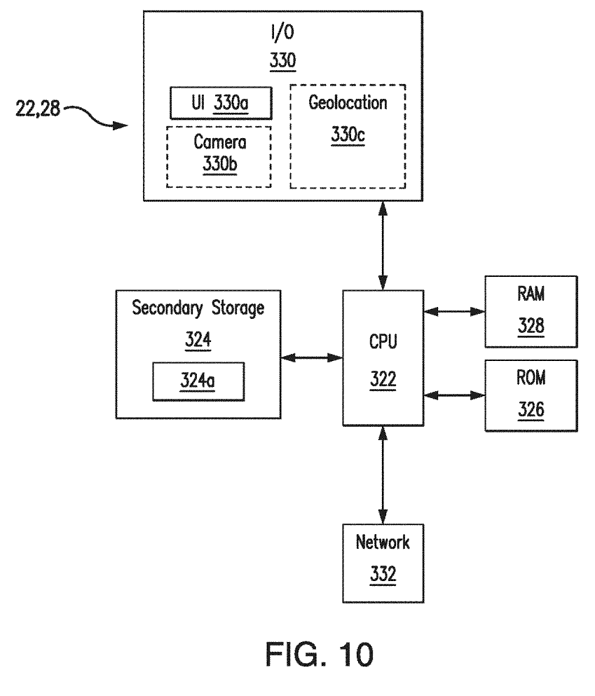

In general terms, both the payee mobile device 22 and the payer mobile device 28 can be considered to be communication devices (which are described below in more detail with reference to FIG. 10). They both include screens 30a, 30b and input devices 32a, 32b. The screens 30a, 30b may be touch sensitive, in which case separate input devices 32a, 32b may not be required and the screens alone may provide a user interface for the communication device. Both the payee mobile device 22 and the payer mobile device 28 are able to communicate with the communication network 24 using respective communication interfaces (not shown). The communication devices 22, 28 may communicate with the communication network 24 via a wireless connection (e.g. GPRS, 3G, 4G, WIFI or Bluetooth) or a wired connection.

The payer associated with the payer mobile device 28 maintains a payment account (e.g. a bank account or a credit card account) at a financial institution (e.g. bank), referred to here as the issuer, and associated with an issuer server 34. The payee associated with the payee mobile device 22 maintains a payment account at a financial institution (e.g. bank), referred to here as the acquirer, and associated with an acquirer server 36. The issuer server 34 and acquirer server 36 are controlled by the service provider server 26 to make payments between the payment accounts they hold. The communication devices 28, 22 can communicate with the service provider server 26 using the communication network 24.

The operation of the components of the network 20 will now be described with reference to the following four example scenarios, in accordance with embodiments of the invention. In each example, the method described eliminates the need for the payer and payee to have accounts with the same bank as well as eliminating any NFC or other external hardware dependency and even eliminating the exchange of account information.

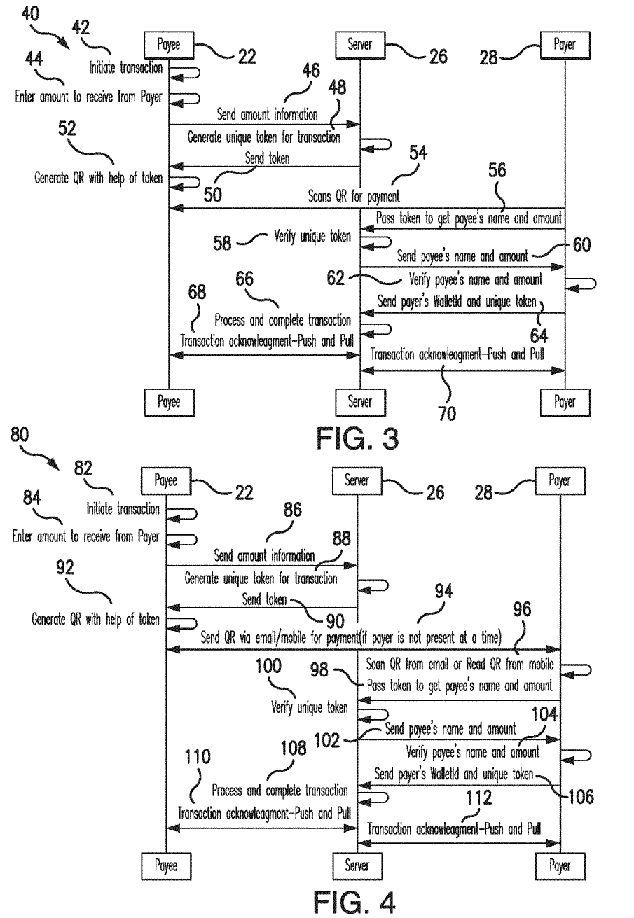

FIG. 3 illustrates a computerised method 40 for securing a payment initiated by a payee in accordance with an embodiment of the invention wherein a customer (payer) wishes to pay a merchant (payee) in person (e.g. at a point-of-sale).

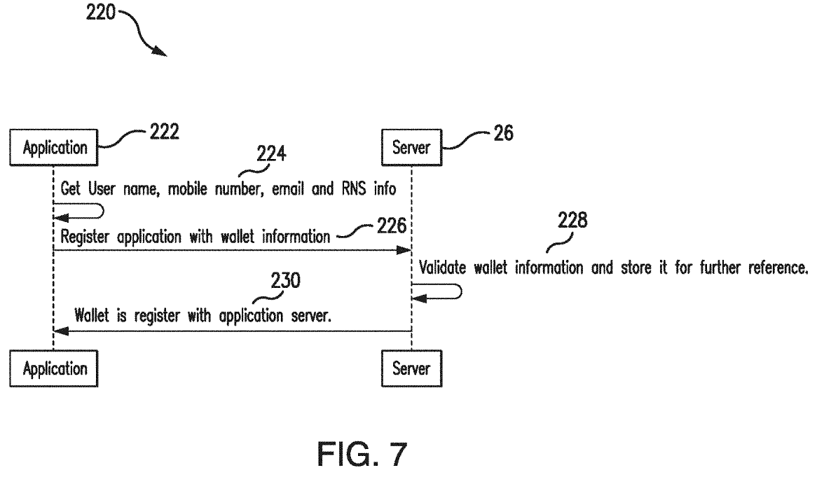

In this embodiment, the payee initiates the transaction in step 42 through his/her communication device 22 which, in this case, may take the form of a point-of-sale (POS) terminal having a transaction application software, in accordance with embodiments of the present invention, installed thereon. In step 44, the payee enters the amount to receive from the payer. This step may comprise the payee scanning/entering items to be purchased into the POS terminal and calculating the total transaction amount due. In step 46, the payee sends a request to the service provider server 26 for a payment transaction to be made, the request comprising a payee identifier and the transaction amount. The payee identifier may be the payee name, residential address, mobile number, email address, company identity code, registration code or user ID (i.e. where the payee has pre-registered with the service provider as will be explained in more detail below with reference to FIG. 7).

Upon receipt of the request from the payee, the service provider server 26 generates, in step 48, a unique token associated with the request and stores the token in a transaction database (not shown) along with the request details (including the payee identifier and transaction amount). The service provider server 26 then transmits the token to the payee communication device 22 in step 50.

In this embodiment, the communication device 22 generates a Quick Response (QR) code encoding the token in step 52, and displays the QR code on the screen 30a for communication to the payer. In step 54, the payer scans the QR code using the payer mobile device 28. Ideally, the payer will scan the QR code using a transaction application installed on his/her mobile device 28. In step 56, the transaction application/payer mobile device 28 will then extract the token from the QR code and transmit the token back to the service provider server 26 via the communication network 24. This transmission will contain a payer identifier which may comprise the payee name, residential address, mobile number, email address, company identity code, registration code or user ID (i.e. where the payer has pre-registered with the service provider as will be explained in more detail below with reference to FIG. 7). The transmission of the token to the service provider server 26 will serve as a request for details of the requested transaction including the payee identifier (e.g. payee name) and transaction amount. In step 58, the service provider server 26 verifies the token and retrieves details of the request from the transaction database. In step 60, the service provider server 26 transmits the payee name and transaction amount to the payer for authorization.

In step 62, the payer checks the payee name and transaction amount and, if the payer wishes the transaction to proceed, the payer authorizes the transaction (e.g. by entering a PIN code into the transaction application on the payer mobile device 28). In step 64, the payer mobile device 28 transmits a message to the service provider server 26 to proceed with the transaction and provides details of the payer payment vehicle along with the token to identify the transaction. In the embodiment illustrated in FIG. 3, the payer payment vehicle is a digital wallet and the details of which are extracted from a user database accessible by the service provider server 26 through use of a wallet ID.

In step 66, the service provider server 26 then completes the payment transaction by transferring the transaction amount from the payer payment vehicle (i.e. payer digital wallet) to a payee payment vehicle (e.g. payee digital wallet) registered in the user database. This step may comprise the service provider 26 communicating with a digital wallet server, which is itself configured to communicate with the acquirer server 36 and issuer server 34 to effect the transfer of funds.

In step 68, the service provider server 26 transmits a (push or pull) notification to the payee communication device 22 confirming that the transaction amount has been successfully transferred. The notification may be by any suitable means, for example, by SMS to a mobile number associated with the payee communication device 22, by email or by another form of electronic notification. In step 70, the service provider server 26 transmits a (push or pull) notification to the payer communication device 28 confirming that the transaction amount has been successfully transferred and the payer may take his/her purchased products.

It should be understood that the same process as described above with reference to FIG. 3 can also be applied to the case where a customer (payer) wishes to pay a merchant (payee) online (e.g. for products purchased through a website). In which case, in step 52, the QR code may be displayed on the payee website for the payer to scan using his/her mobile device 28.

FIG. 4 illustrates a computerised method 80 for securing a payment initiated by a payee in accordance with an embodiment of the invention wherein a customer (payer) wishes to pay a merchant (payee) for products purchased by telephone. In this case, the method is similar to that described above in relation to FIG. 3 with the exception that the QR code is communicated to the payer via email or a mobile telephone network. In other embodiments, the token may be communicated directly to the payer via email or a mobile telephone network (e.g. without it being encoded into a QR code).

Accordingly, as above, in the method illustrated in FIG. 4 the payee initiates the transaction in step 82 through his/her communication device 22 which, in this case, may take the form of a computer having a transaction application software, in accordance with embodiments of the present invention, installed thereon. In step 84, the payee enters the amount to receive from the payer (i.e. the value of the products being purchased). In step 86, the payee sends a request to the service provider server 26 for a payment transaction to be made, the request comprising a payee identifier and the transaction amount. Once again, the payee identifier may be the payee name, residential address, mobile number, email address, company identity code, registration code or user ID (i.e. where the payee has pre-registered with the service provider as will be explained in more detail below with reference to FIG. 7).

Upon receipt of the request from the payee, the service provider server 26 generates, in step 88, a unique token associated with the request and stores the token in a transaction database (not shown) along with the request details (including the payee identifier and transaction amount). The service provider server 26 then transmits the token to the payee communication device 22 in step 90.

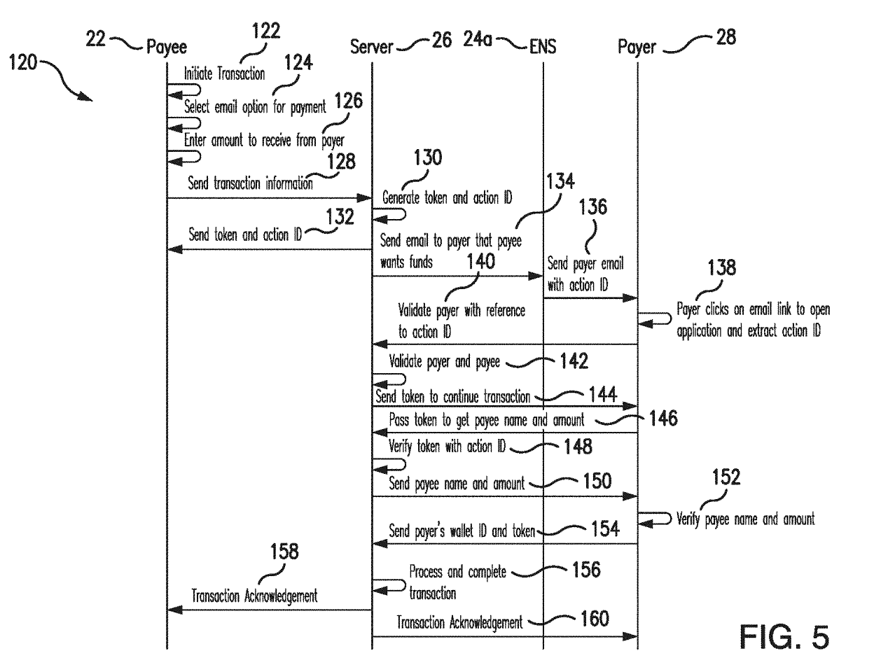

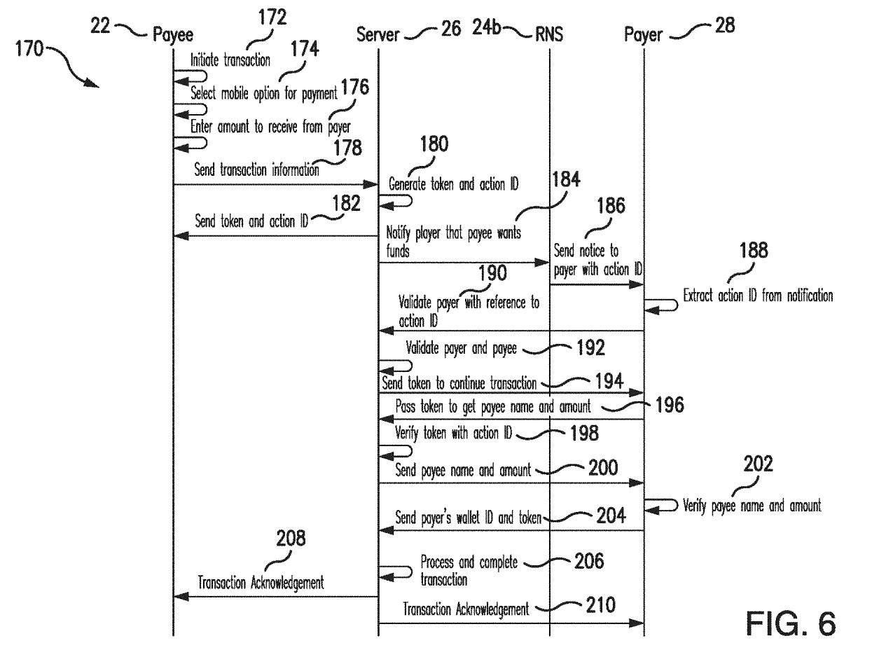

In this embodiment, the communication device 22 generates a Quick Response (QR) code encoding the token in step 92, and transmits the QR code to the payer in step 94. The method of communication may be by email or via a mobile telephone network and more details explaining how each option may operate in practice are provided below with reference to FIGS. 5 and 6.

In step 96, the transaction application/payer mobile device 28 extracts the token from the QR code and, in step 98, transmits the token back to the service provider server 26 via the communication network 24. As before, this transmission will contain a payer identifier which may comprise the payee name, residential address, mobile number, email address, company identity code, registration code or user ID (i.e. where the payer has pre-registered with the service provider as will be explained in more detail below with reference to FIG. 7). The transmission of the token to the service provider server 26 will serve as a request for details of the requested transaction including the payee identifier (e.g. payee name) and transaction amount. In step 100, the service provider server 26 verifies the token and retrieves details of the request from the transaction database. In step 102, the service provider server 26 transmits the payee name and transaction amount to the payer for authorization.

In step 104, the payer checks the payee name and transaction amount and, if the payer wishes the transaction to proceed, the payer authorizes the transaction (e.g. by entering a PIN code into the transaction application on the payer mobile device 28). In step 106, the payer mobile device 28 transmits a message to the service provider server 26 to proceed with the transaction and provides details of the payer payment vehicle along with the token to identify the transaction. In the embodiment illustrated in FIG. 4, the payer payment vehicle is, again, a digital wallet and the details of which are extracted from a user database accessible by the service provider server 26 through use of a wallet ID.

In step 108, the service provider server 26 then completes the payment transaction by transferring the transaction amount from the payer payment vehicle (i.e. payer digital wallet) to a payee payment vehicle (e.g. payee digital wallet) registered in the user database.

In step 110, the service provider server 26 transmits a (push or pull) notification to the payee communication device 22 confirming that the transaction amount has been successfully transferred. The notification may be by any suitable means, for example, by SMS to a mobile number associated with the payee communication device 22, by email or by another form of electronic notification. In step 112, the service provider server 26 transmits a (push or pull) notification to the payer communication device 28 confirming that the transaction amount has been successfully transferred.

FIG. 5 shows in more detail an embodiment 120 of the invention in which the token is relayed to the payer by email via an email notification server 24a. In this case, the payee need not be a merchant but, instead, may be an individual such as a friend or family member of the payer.

In step 122, the payee initiates the transaction through his/her communication device 22 which, in this case, may take the form of a mobile device such as a smartphone or tablet having a transaction application software, in accordance with embodiments of the present invention, installed thereon. In step 124, the payee selects to notify the payer of the request for payment via email. In step 126, the payee enters the transaction amount that he/she wishes to receive from the payer (i.e. money owed). In step 128, the payee sends a request to the service provider server 26 for a payment transaction to be made, the request comprising a payee identifier, payer identifier and the transaction amount. As before, the payee identifier and payer identifier may comprise the name, residential address, mobile number, email address, individual identity code, registration code or user ID (i.e. where the payee/payer has pre-registered with the service provider as will be explained in more detail below with reference to FIG. 7).

Upon receipt of the request from the payee, the service provider server 26 generates, in step 130, a unique token and an action ID associated with the request and stores the token and action ID in a transaction database (not shown) along with the request details (including the payee identifier, payer identifier and transaction amount). In this embodiment, the token is a code used by the service provider server 26 to identify the current transaction such that the payee and payer for the transaction can be identified from it. The action ID provides an additional layer of security by being a unique code used to verify the authenticity of the transaction with the payer before the token is communicated to the payer. The service provider server 26 then transmits the token and action ID to the payee communication device 22 in step 132. The payee may subsequently check the status of the transaction by sending a request to the service provider server 26 including the action ID.

In step 134 the service provider server 26 sends an email to the email notification server (ENS) 24a indicating that the payee wishes to receive funds from the payer and providing the payer email address pre-registered with the service provider. The ENS 24a then sends the email onto the payer 28 along with the action ID in step 136.

In step 138 the payer clicks on a link in the email to open a transaction application which extracts the action ID from the email. The transaction application will then send a notification to the service provider server 26 to validate the payer with respect to the action ID in step 140. In step 142 the service provider server 26 validates the payer and payee information for the current transaction and in step 144 the service provider transmits the token to the payer to continue with the transaction.

In step 146 the payer transmits the token back to the service provider server 26 to retrieve the payee's name and transaction amount. In step 148 the service provider server 26 verifies the token with the action ID and in step 150 sends the payee's name and transaction amount to the payer.

In step 152 the payer verifies the payee name and transaction amount and in step 154 sends details of the payer's digital wallet (i.e. wallet ID or other payment vehicle) to the service provider server 26 along with the token. In step 156 the service provider server 26 uses the wallet ID to complete the transaction for the transaction amount (e.g. by using an existing payment network and details of the transaction). In step 158 a transaction acknowledgement is sent to the payee confirming that the transaction has been completed and in step 160 a transaction acknowledgement is sent to the payer confirming that the transaction has been completed.

FIG. 6 shows in more detail an embodiment 170 of the invention in which the token is relayed to the payer via a mobile telephone network operating via a remote notification server 24b. As above, the payee need not be a merchant but, instead, may be an individual such as a friend or family member of the payer.

In step 172, the payee initiates the transaction through his/her communication device 22 which, in this case, may take the form of a mobile device such as a smartphone or tablet having a transaction application software, in accordance with embodiments of the present invention, installed thereon. In step 174, the payee selects to notify the payer of the request for payment via a mobile telephone communication (e.g. SMS). In step 176, the payee enters the transaction amount that he/she wishes to receive from the payer (i.e. money owed). In step 178, the payee sends a request to the service provider server 26 for a payment transaction to be made, the request comprising a payee identifier, payer identifier and the transaction amount. As before, the payee identifier and payer identifier may comprise the name, residential address, mobile number, email address, individual identity code, registration code or user ID (i.e. where the payee/payer has pre-registered with the service provider as will be explained in more detail below with reference to FIG. 7).

Upon receipt of the request from the payee, the service provider server 26 generates, in step 180, a unique token and an action ID associated with the request and stores the token and action ID in a transaction database (not shown) along with the request details (including the payee identifier, payer identifier and transaction amount). In this embodiment, the token is a code used by the service provider server 26 to identify the current transaction such that the payee and payer for the transaction can be identified from it. The action ID provides an additional layer of security by being a unique code used to verify the authenticity of the transaction with the payer before the token is communicated to the payer. The service provider server 26 then transmits the token and action ID to the payee communication device 22 in step 182. The payee may subsequently check the status of the transaction by sending a request to the service provider server 26 including the action ID.

In step 184 the service provider server 26 sends an notification to the remote notification server (RNS) 24b indicating that the payee wishes to receive funds from the payer and providing the payer mobile number pre-registered with the service provider. The RNS 24b then sends the notification onto the payer 28 along with the action ID in step 186.

In step 188 the payer clicks on a link in the notification to open a transaction application which extracts the action ID. The transaction application will then send a notification to the service provider server 26 to validate the payer with respect to the action ID in step 190. In step 192 the service provider server 26 validates the payer and payee information for the current transaction and in step 194 the service provider transmits the token to the payer to continue with the transaction.

In step 196 the payer transmits the token back to the service provider server 26 to retrieve the payee's name and transaction amount. In step 198 the service provider server 26 verifies the token with the action ID and in step 200 sends the payee's name and transaction amount to the payer.

In step 202 the payer verifies the payee name and transaction amount and in step 204 sends details of the payer's digital wallet (i.e. wallet ID or other payment vehicle) to the service provider server 26 along with the token. In step 206 the service provider server 26 uses the wallet ID to complete the transaction for the transaction amount (e.g. by using an existing payment network and details of the transaction). In step 208 a transaction acknowledgement is sent to the payee confirming that the transaction has been completed and in step 210 a transaction acknowledgement is sent to the payer confirming that the transaction has been completed.

FIG. 7 shows a registration procedure 220 for the payee or payer to register details with the service provider server 26 for use in embodiments of the invention. The registration procedure 220 comprises the payee/payee using a registration application 222 on his/her communication device 22/28. In step 224, the payee/payer enters one or more of his/her user name, mobile number, email address and remote network server address. In step 226, the payee/payer registers his/her digital wallet information (i.e. wallet ID) with the application and the registered details are communicated over the communication network 24 to the service provider server 26. In other embodiments, the payee/payer may register a different type payment vehicle (e.g. a payment card or account details). In step 228, the service provider server 26 validates the digital wallet information and stores it in a user database for future reference. In step 230, the service provider server 26 transmits a notification to the application 22 confirming that the digital wallet information has been duly registered for future use by the payee/payer.

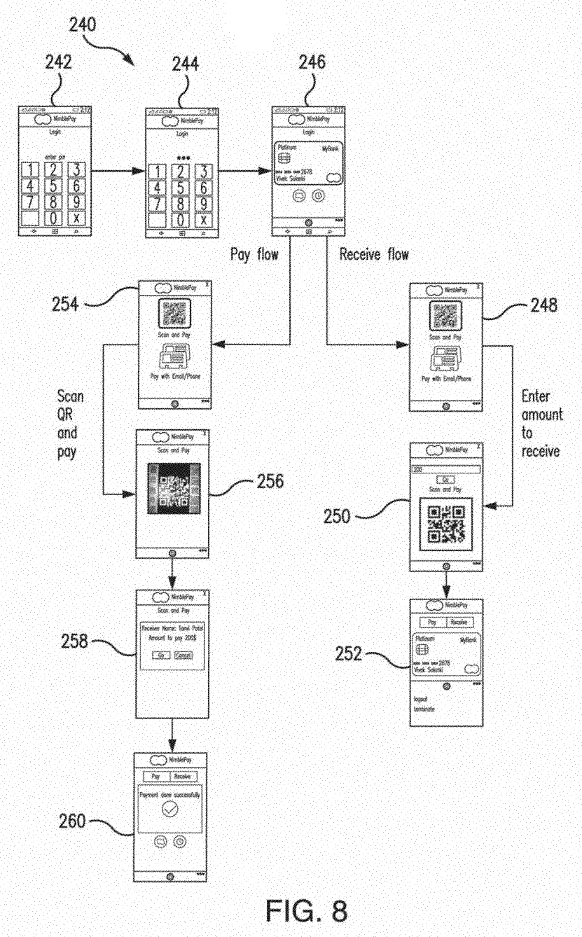

FIG. 8 shows flow-chart 240 of a user application interface for use by a payer or payee in accordance with some embodiments of the invention. In step 242, the payer/payee is prompted to enter a PIN to access the application. In step 244, the PIN is entered and in step 246, the payer/payee is presented with a home page through which he/she can select to pay (i.e. send funds) or receive (i.e. request funds).

In the case where the user wishes to receive funds (as payee), step 248 prompts the payee to select whether he/she wishes to communicate with the payer using a QR code or via email or mobile telephone. In step 250, the user has selected to use a QR code and is presented with a QR code for the payer to scan. Once this action is complete, the application returns to the home page in step 252.

In the case where the user wishes to pay funds (as payer), step 254 prompts the payer to select whether he/she wishes to pay using a QR code or via email or mobile telephone. In step 256, the user has selected to use a QR code and is prompted to scan the QR code provided by the payee. In step 258, the payer is presented with the payee/receiver name and transaction amount for authorization. If the payer selects to proceed with the transaction, the application will confirm when the funds have been transferred in step 260.

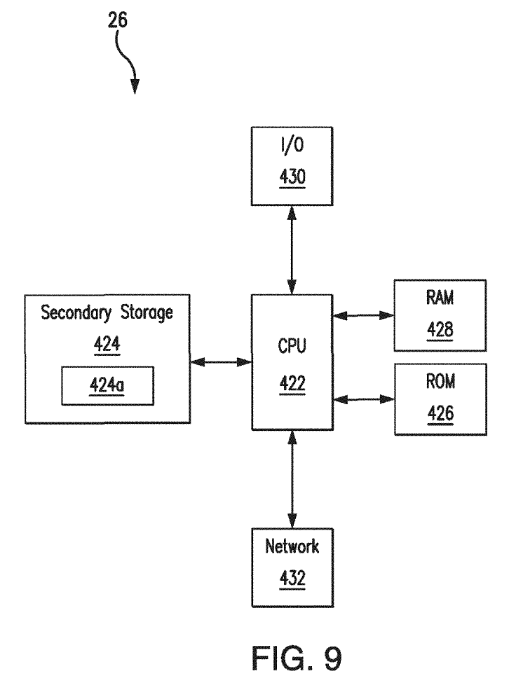

FIG. 9 is a block diagram showing a technical architecture of the service provider server 26. The issuer server 34 or acquirer server 36 may also have this technical architecture.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 420 to provide the functionality of a number of servers that is not directly bound to the number of computers in the technical architecture 420. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 10 is a block diagram showing a technical architecture of the payer mobile device 28 and payee mobile device 22.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a. In the case of the customer mobile device 28, a camera 330b and a geolocation module 330c may also be provided. The UI 330a may comprise a touch screen, keyboard, keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a processing component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiments can be made in accordance with the appended claims.

1. A method of securing a payment initiated by a payee comprising the operations of:
a) a service provider (i) receiving a request from a payee for a payment transaction to be made, the request comprising a payee identifier, payer identifier and transaction amount; (ii) generating a token associated with the request; and (iii) transmitting the token to the payer;
b) the service provider (i) receiving the token and a payer identifier from the payer; (ii) using the token to retrieve details of the request; and (iii) transmitting the payee identifier and transaction amount to the payer for authorization;
c) upon authorization, the service provider receiving from the payer, identification of a payer payment vehicle to be used for the payment transaction; and
d) the service provider completing the payment transaction from the payer payment vehicle to a payee payment vehicle.

2. The method according to claim 1 wherein the token is generated using the payee identifier and/or the transaction amount.

3. The method according to claim 1 wherein the step of transmitting the token to the payer comprises displaying or otherwise transmitting a Quick Response (QR) code.

4. The method according to claim 1 wherein the step of transmitting the token to the payer comprises transmitting the token via an email, Short Message Service (SMS), Near-Field Communication (NFC), Bluetooth or other communication means to a payer's mobile device.

5. The method according to claim 1 wherein the payee identifier and/or the payer identifier comprises one or more of a name, residential address, mobile number, email address, company/individual identity code, registration code or user ID.

6. The method according to claim 1 wherein the payer payment vehicle and/or the payee payment vehicle comprises a cashless payment mechanism.

7. The method according to claim 6 wherein the cashless payment mechanism comprises one or more of a credit card, a debit card, a prepaid card, a charge card, a membership card, a promotional card, a frequent flyer card, an identification card, a gift card, a digital wallet and any other physical or electronic device that holds payment account information.

8. The method according to claim 1 wherein in operation d), the service provider completes the payment transaction through a payment network.

9. The method according to claim 8 wherein the service provider transmits an authorization request to an acquirer bank associated with the payee payment vehicle, the acquirer bank processes the authorization request and transmits a payment request to an issuer bank associated with the payer payment vehicle and, once approved by the issuer bank, the requested payment is transferred to the acquirer bank for storing in the payee payment vehicle.

10. The method according to claim 1 wherein the service provider comprises a digital wallet service provider configured to complete the payment transaction through a digital wallet payment.

11. The method according to claim 1 further comprising a registration procedure wherein the payer and/or payee pre-register with the service provider to make and/or receive payments through the service provider.

12. The method according to claim 1 wherein the service provider creates and/or maintains a user database comprising details of registered payers and/or payees.

13. The method according to claim 12 wherein the details comprise one or more of: a payee/payer identifier, name, residential address, mobile number, email address, company/individual identity code, registration code, user ID and registered payment vehicle.

14. The method according to claim 13 wherein the identification of a payer payment vehicle comprises confirmation that a registered payment vehicle associated with the payer in the database is to be used.

15. The method according to claim 1 wherein the identification of a payer payment vehicle comprises identification of a cashless payment mechanism such as a payment card, payment account or digital wallet.

16. The method according to claim 1 wherein the service provider creates and/or maintains a transaction database comprising details of the requested payment transactions.

17. The method according to claim 16 wherein the transaction database comprises the payee identifier, transaction amount and token associated with the request.

18. The method according to claim 17 wherein in operation b), the service provider uses the token to retrieve the payee identifier and transaction amount from the transaction database.

19. The method according to claim 1 wherein upon authorization, the service provider checks that it has not previously received an authorization pertaining to the same token, and operation d) is only performed in the case that the check has a positive result.

20. A computerized network configured to carry out the method according to claim 1.

21. A service provider server for securing a payment initiated by a payee, comprising a processor arranged to:
a) receive a request from a payee for a payment transaction to be made, the request comprising a payee identifier, payer identifier and transaction amount;
b) generate a token associated with the request;
c) transmit the token to the payer;
d) receive the token and a payer identifier from the payer;
e) use the token to retrieve details of the request;
f) transmit the payee identifier and transaction amount to the payer for authorization;
g) upon authorization, receive from the payer, identification of a payer payment vehicle to be used for the payment transaction; and
h) complete the payment transaction from the payer payment vehicle to a payee payment vehicle.

22. The service provider according to claim 21 wherein the processer is arranged to encrypt the token before transmitting the token to the payee and to decrypt the token, upon receiving the token from the payer.

23. The service provider according to claim 21 further configured to handle payment transactions initiated by the payer.

24. A non-transitory computer-readable medium having stored thereon program instructions for causing at least one processor to perform the method according to claim 1.
